(19) United States
(12) Patent Application Publication
(10) Pub. No.: US 2024/0045996 A1
(43) Pub. Date: Feb. 8, 2024

(54) Systems and Methods for Biometrics-based Secure Data Encryption and Data Signature

(71) Applicant: Dapple Security, Inc., Centennial, CO (US)

(72) Inventors: Gadalia Montoya Weinberg O'Bryan, Centennial, CO (US); William Rodgers Ackerly, Chevy Chase, MD (US)

(21) Appl. No.: 18/229,948

(22) Filed: Aug. 3, 2023

Related U.S. Application Data
(60) Provisional application No. 63/394,734, filed on Aug. 3, 2022.
(60) Provisional application No. 63/427,352, filed on Nov. 22, 2022.
(60) Provisional application No. 63/456,670, filed on Apr. 3, 2023.

(51) Int. Cl. G06F 21/64; G06F 21/32; G06F 21/60

(52) U.S. Cl. CPC G06F 21/64; G06F 21/32; G06F 21/602

(57) ABSTRACT

A method for multi-factor, biometrics-based, secure data signature includes generating, by a biometrics reader device, a first biometric measurement using a physical characteristic of a user. The method includes selecting, by at least one noise-resistant feature transformation and hashing module executing on a processor of a computing device, a code word in a set of code words, wherein selecting further comprises applying an error correcting code to the first biometric measurement. The method includes generating, by the at least one noise-resistant feature transformation and hashing module, a first hash, wherein generating further comprises executing a hashing algorithm and using the selected code word as input to the hashing algorithm. The method includes generating, by the at least one noise-resistant feature transformation and hashing module, a public key and a private key, using the first hash. The method includes electronically signing, with the private key, data associated with the user.

### CROSS-REFERENCE TO RELATED APPLICATIONS

This application claims the benefit of U.S. Provisional Patent Application Ser. No. 63/394,734, filed on Aug. 3, 2022, entitled “Systems and Methods for Biometrics-based Secure Data Recovery,” and claims the benefit of U.S. Provisional Patent Application Ser. No. 63/427,352, filed on Nov. 22, 2022, entitled “Systems and Methods for Biometrics-based Secure Data Recovery,” and claims the benefit of U.S. Provisional Patent Application Ser. No. 63/456,670, filed on Apr. 3, 2023, entitled “Systems and Methods for Biometrics-based Secure Data Encryption and Data Signature,” each of which is hereby incorporated by reference.

### BACKGROUND

The methods and systems described herein relate to methods and systems for secure recovery of data, such as a private key data or of credential data or of other secret data, using biometrics alone or in conjunction with other factors.

Conventionally, systems for retrieving secure data typically require a user to input a credential—including, without limitation, passwords, passcodes, private keys, or other types of credentials. Typically, if the user forgets or loses the credential, or in the event of a death of the user or other circumstance in which the user is no longer able to present the credential, there are complex processes for retrieving the credentials or the system will reset the credential; the more secure the system, the harder it is to receive a new credential. Therefore, there are conventional solutions for saving credentials either to a personal device owned by the user or to a server device on which the user can store credentials for later retrieval (either owned and maintained by the user or by a third party). Credentials stored in such devices are typically stored in a hashed format (the definition of ‘hash’, as used throughout this document, is any algorithm that obfuscates the original input in a way such that it is extremely difficult to recover the original input given the obfuscated output) and not unencrypted (i.e., not “in the clear”) and themselves protected by another, master credential (such as, for example, a master password) so that if the devices themselves are compromised, the credentials are not compromised. However, if the user loses the master credential or the physical device, then the process for retrieving the stored credentials is complex or, in some implementations, impossible, depending on how much data the device stored about the user and the user's master credential. Similarly, users wishing to secure any type of data, not just credentials, lack conventional functionality for securing and later accessing the data in a manner that is resilient to the passage of time or the loss of master credentials and/or devices, whether the data is a type of application or a file or an entire computing device. Given that many valuable assets are stored digitally by both individuals and organizations, including, but not limited to financial, health, confidential, and proprietary data, losing access to such data can cause irreparable harm to financial, physical, and reputational wellbeing. Furthermore, given the rise of the “internet of things” (IoT), and the ability of everyday objects such as doorbells and thermostats to be accessed via a computer, if a user loses a credential for accessing such IoT devices, the user may lose access to critical functionality in their home or office infrastructure. Therefore, there is a need for methods and systems for secure retrieval of lost credentials.

Biometrics include body measurements and calculations related to human characteristics, typically relating to distinctive, measurable characteristics of an individual. Examples include, without limitation, fingerprints, palms, DNA, patterns in irises and/or retinas, and facial features. Some conventional approaches to the problems of storing and retrieving credentials rely on the use of biometrics. For example, a user may execute an application on a device that scans and stores features of a biometric identifier on the device and use those features as a type of password for accessing stored credentials. At a subsequent time, when the user wishes to access the stored credentials, the user may again execute the application to scan the features of their biometric identifiers and compare those scanned features to the previously stored features; if there is a match, the application allows the user to access the credentials. However, conventional approaches to using biometrics typically require storing the scanned features (e.g., of a fingerprint or of a face)—or a set of derived features—to be stored in the clear or otherwise unsecured in a secured location (such as a secure enclave on a chip in the computing device), which limits the availability of the scanned features—the user could not access their credentials from a different machine that lacks access to the chip so if they lose the machine with the chip, they lose the credentials and the ability to retrieve those credentials. Therefore, many users save credentials on multiple machines or use applications for storing credentials on a third-party server that can be accessed from multiple machines and accept the deficiencies of those systems, as described above.

Conventionally, biometric data is not stored in a hashed format because there may be fluctuations to the measurements across periods of time. For example, pressure applied when generating a fingerprint measurement may change each time a user has the fingerprint measured, even though the fingerprint itself does not change. As another example, the surface of the user's skin may change—cuts and scrapes, for example, may impact the measurements taken as part of a biometric process. Since the same user's data may vary over time, a hash of biometric data stored at one point in time may not match a hash of biometric data taken at a subsequent point in time, which would result in the system failing to authenticate the user based on the same physical characteristic.

Some approaches to generating reliable hashes for biometrics exist. However, such approaches are typically used solely in the case where the biometric data is the credential to be stored and not the means for accessing other stored credentials or for any use in a disaster recovery scenario or in a scenario in which the original enrollment device is lost. For example, a system may require a user to provide a biometric measurement (e.g., use a fingerprint reader) in order to access a resource—when the user provides the biometric measurement, the system compares the biometric measurement with a previously stored and hashed biometric measurement to determine whether or not to allow the user to access the resource. However, such systems do not typically contemplate using the hashed biometric measurement as a means for recovering other credentials and only support use of stored biometrics as plain authenticators.

Therefore, there is a need for technology for generating a hash of a biometric measurement for use in retrieving other secured data, without requiring the storage of raw or derived biometric data.

### BRIEF SUMMARY

In one aspect, a method for multi-factor, biometrics-based, secure data signature includes generating, by a biometrics reader device, a first biometric measurement using a physical characteristic of a user. The method includes selecting, by at least one noise-resistant feature transformation and hashing module executing on a processor of a computing device, a code word in a set of code words, wherein selecting further comprises applying an error correcting code to the first biometric measurement. The method includes generating, by the at least one noise-resistant feature transformation and hashing module, a first hash, wherein generating further comprises executing a hashing algorithm and using the selected code word as input to the hashing algorithm. The method includes generating, by the at least one noise-resistant feature transformation and hashing module, a public key and a private key, using the first hash. The method includes electronically signing, with the private key, data associated with the user.

In another aspect, a method for biometrics-based secure data recovery includes generating, by a biometrics reader device, a first biometric measurement using a physical characteristic of a user. The method includes selecting, by at least one noise-resistant feature transformation and hashing module executing on a processor of a computing device, a code word in a set of code words, wherein selecting further comprises applying an error correcting code to the first biometric measurement. The method includes generating, by the at least one noise-resistant feature transformation and hashing module, a first hash of the code word. The method includes encrypting, by an encryption module of the computing device, a data item, using the generated hash as input to an encryption algorithm. The method includes receiving, by the processor, user input identifying a condition satisfying a threshold requirement for use of the first biometric measurement to retrieve the data item. The method includes generating, by the biometrics reader device, a second biometric measurement using the physical characteristic of the user. The method includes applying, by the at least one noise-resistant feature transformation and hashing module, the error correcting code to the second biometrics measurement. The method includes generating a second hash using an output of applying the error correcting code to the second biometrics measurement. The method includes decrypting, by the processor, the data item using the generated hash as input to an decryption algorithm. The method includes providing, by the encryption module, the user with access to the data item.

In still another aspect, a method for biometrics-based secure data recovery by a user with at least one profile includes generating, by a biometrics reader device, a first biometric measurement using a physical characteristic of a user. The method includes selecting, by at least one noise-resistant feature transformation and hashing module executing on a processor of a computing device, a code word in a set of code words, wherein selecting further comprises applying an error correcting code to the first biometric measurement. The method includes generating, by the at least one noise-resistant feature transformation and hashing module, a hash of the code word. The method includes associating, by the processor, the generated first hash with a first user profile of the user. The method includes encrypting, by an encryption module of the computing device, a data item, using the generated hash as input to an encryption algorithm. The method includes receiving, by the processor, user input identifying a condition satisfying a threshold requirement for use of the first biometric measurement to retrieve the data item. The method includes receiving, by the processor, user input identifying the first user profile for use in retrieving the data item. The method includes generating, by the biometrics reader device, a second biometric measurement using the physical characteristic of the user. The method includes applying, by the at least one noise-resistant feature transformation and hashing module, the error correcting code to the second biometrics measurement. The method includes generating a second hash using an output of applying the error correcting code to the second biometrics measurement. The method includes decrypting, by the processor, the data item using the generated hash as input to the decryption algorithm. The method includes providing, by the encryption module, the user with access to the data item.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting one embodiment of a system for biometrics-based secure data recovery;

FIG. 1B is a block diagram depicting one embodiment of a system for biometrics-based secure data recovery;

FIG. 1C is a block diagram depicting one embodiment of a system for single factor storage;

FIG. 1D is a block diagram of one embodiment of a system providing functionality for single factor recovery;

FIG. 1E is a block diagram depicting one embodiment of a method for comparing different codes to an enrolled code;

FIG. 1F is a flow diagram depicting one embodiment of a method for a key storage and recovery process using a single biometric;

FIG. 2A is a flow diagram depicting an embodiment of a method for biometrics-based secure data recovery using a generated helper string;

FIG. 2B is a flow diagram depicting an embodiment of a method for biometrics-based secure data recovery;

FIG. 2C is a flow diagram depicting one embodiment of a method for generating, by a biometrics reader device, a first biometric measurement using a physical characteristic of a user without using a helper string;

FIG. 3 is a flow diagram depicting one embodiment of a method for biometrics-based secure data recovery by a user with at least one profile;

FIG. 4 is a flow diagram depicting one embodiment of a method for multi-factor, biometrics-based, secure data recovery by a user with at least one profile;

FIG. 5A is a block diagram depicting one embodiment of a method for using a biometric measurement with a persona;

FIG. 5B is a flow diagram depicting one embodiment of a method for a key recovery using a single biometric and a persona;

FIG. 6A is a flow diagram depicting one embodiment of a method for biometrics-based authentication by a user with at least one profile;

FIG. 6B is a flow chart depicting one embodiment of a method for performing authentication using a single biometric and a persona;

FIG. 7 is a flow diagram depicting one embodiment of a method for multi-factor, biometrics-based, authentication by a user with at least one profile;

FIG. 8 is a flow diagram depicting one embodiment of a method for multi-factor, biometrics-based, secure data encryption by a user;

FIG. 9 is a flow diagram depicting one embodiment of a method for multi-factor, biometrics-based, secure data signature by a user;

FIG. 10 is a flow diagram depicting one embodiment of a method for multi-factor, biometrics-based encryption;

FIG. 11 is a flow diagram depicting one embodiment of a method for multi-factor, biometrics-based digital signatures;

FIGS. 12A-12C are block diagrams depicting embodiments of computers useful in connection with the methods and systems described herein.

### DETAILED DESCRIPTION

The methods and systems described herein may provide functionality for generating a hash of a biometric measurement for use in authenticating a user without storing the biometric measurement itself nor features of the biometric. The methods and systems described herein extend the use of such hashes of biometric measurements for use when certain conditions are met and the biometrics are needed to retrieve other credentials. The methods and systems described herein also do not assume that only the original user is able to recover the credentials, providing functionality to share or assign that right with other authorized individuals.

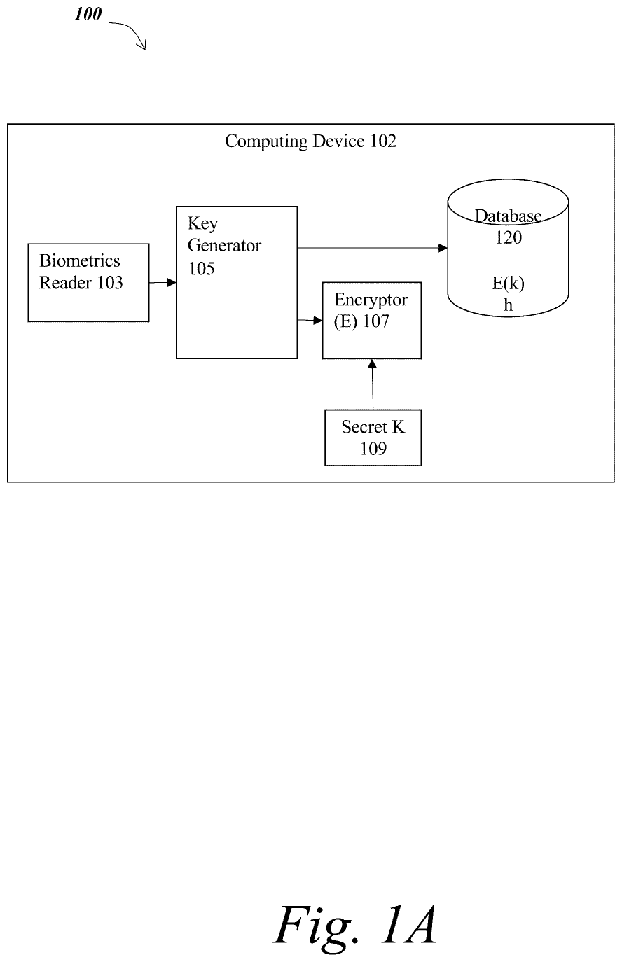

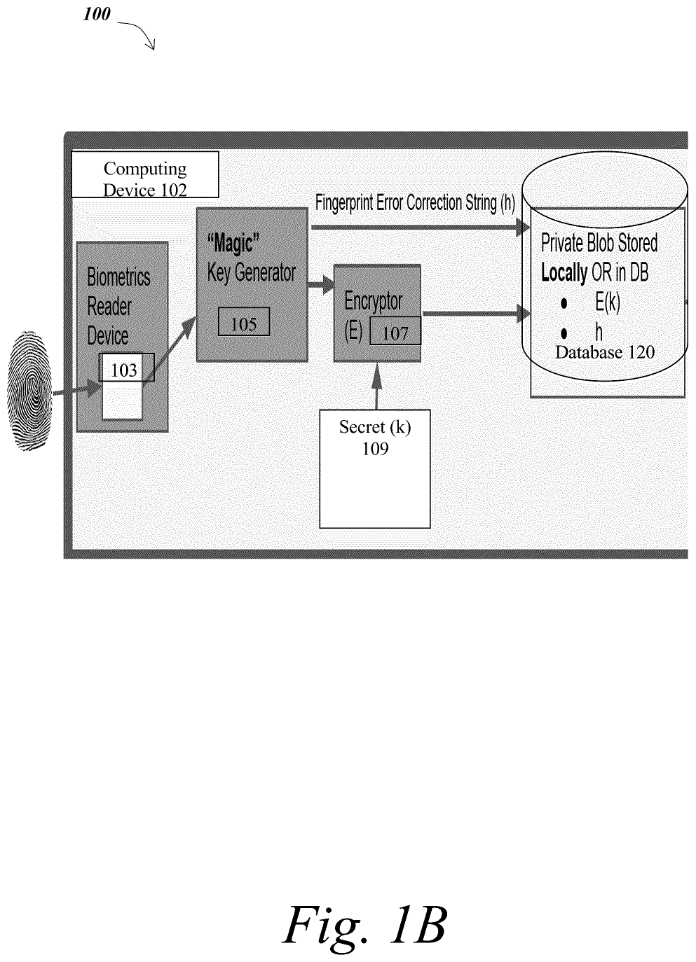

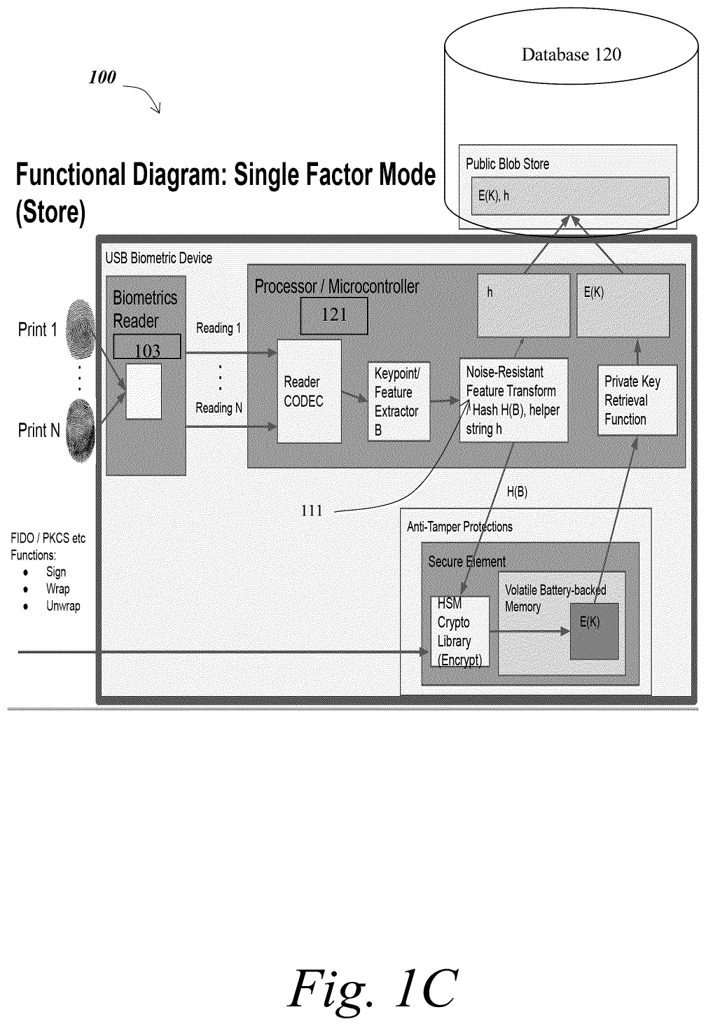

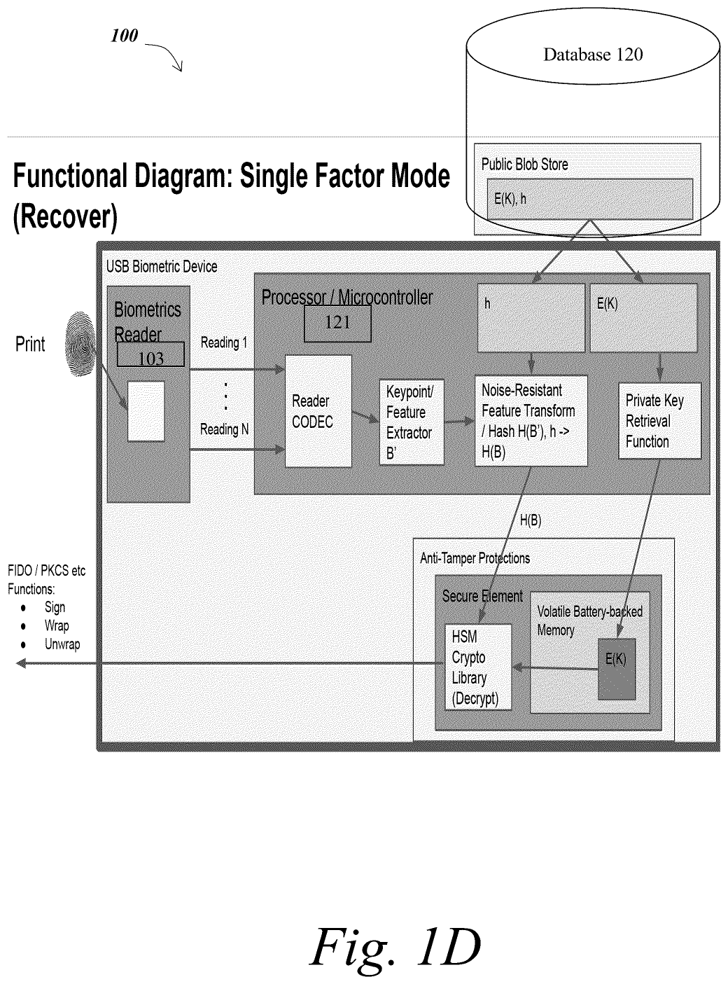

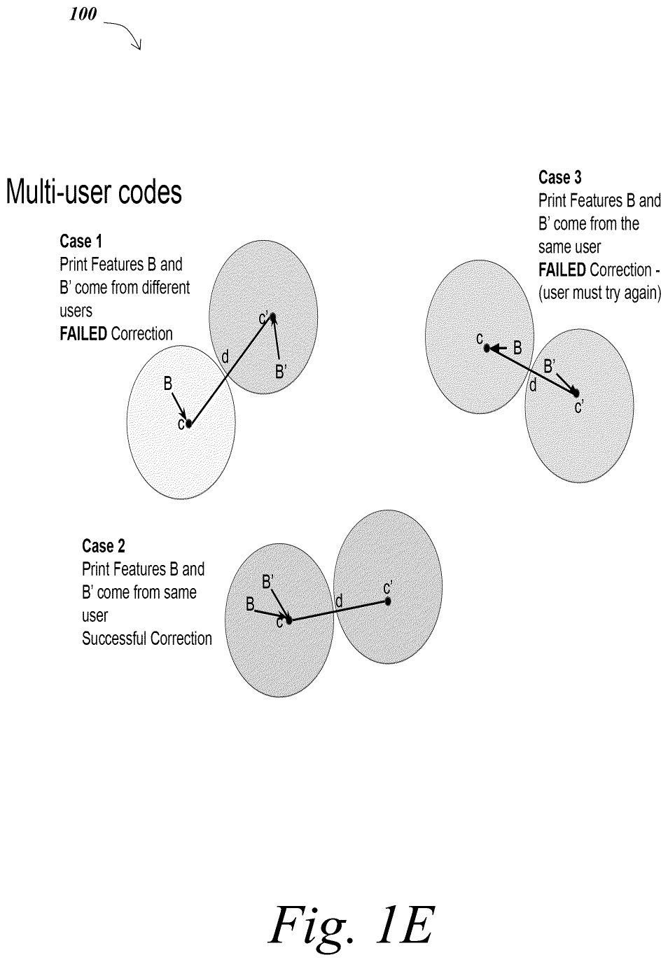

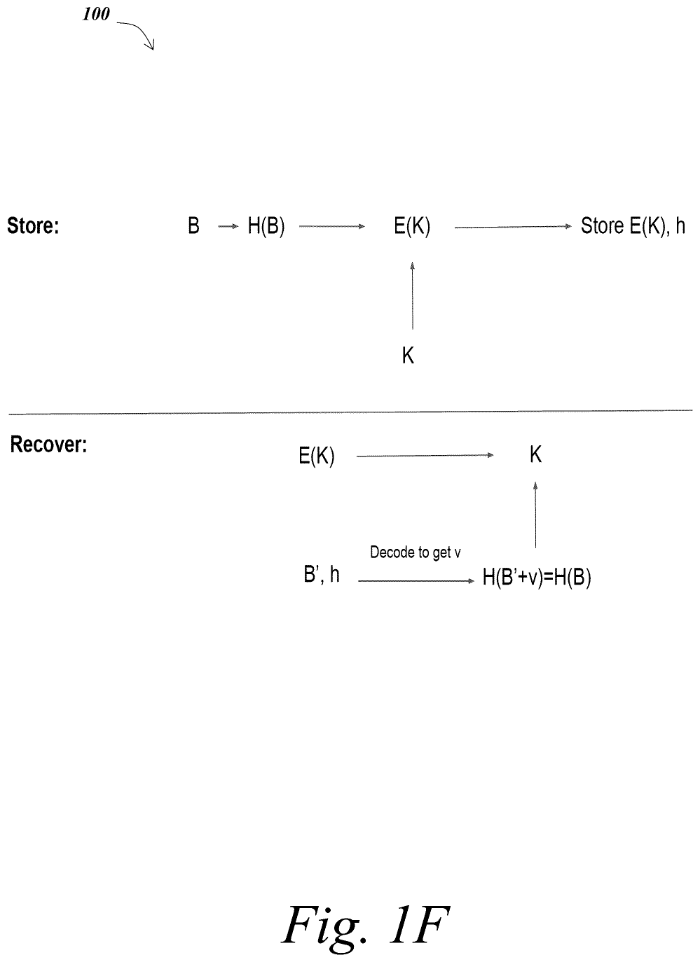

Referring now to FIG. 1A, a block diagram depicts one embodiment of a system 100 for biometrics-based secure data recovery. In brief overview, the system 100 includes a computing device 102, a biometrics reader 103, a key generator 105, an encryptor (E) 107, a secret (K) 109, and a database 120. The database 120 may store an encryption of the secret and an error correction string h. The computing device 102 executes the key generator 105 and the encryptor 107. The computing device is in communication with the database 120.

The biometrics reader 103 may be provided as a software component. The biometrics reader 103 may be provided as a hardware component. The biometrics reader 103 may include both a software component and a hardware component. The computing device 102 may execute the biometrics reader 103.

In some embodiments, users may authenticate themselves using the methods and systems described herein while using dedicated hardware as the biometrics reader device, including, without limitation, a GT-521F52 series Fingerprint Sensor, a USB Dongle Expansion Breakout Module Kit for ATECC608A—Secure Element Raspberry Pi Zero/W, or a ATECC608A—Secure Element.

The key generator 105 may be provided as a software component. The key generator 105 may be provided as a hardware component. The computing device 102 may execute the key generator 105.

The encryptor 107 may be provided as a software component. The encryptor 107 may be provided as a hardware component. The computing device 102 may execute the encryptor 107.

The computing device 102 may receive the secret 109 from a user and transmit the secret 109 to the encryptor 107. The encryptor 107 may receive the secret 109 directly from a user. The secret 109 may be any data item that can be encrypted by the encryptor 107.

The database 120 may store data including, for example, secrets (e.g., data to be encrypted), hashes, and encrypted versions of the secrets. The database 120 may be an ODBC-compliant database. For example, the database 120 may be provided as an ORACLE database, manufactured by Oracle Corporation of Redwood Shores, CA. In other embodiments, the database 120 can be a Microsoft ACCESS database or a Microsoft SQL server database, manufactured by Microsoft Corporation of Redmond, WA. In other embodiments, the database 120 can be a SQLite database distributed by Hwaci of Charlotte, NC, or a PostgreSQL database distributed by The PostgreSQL Global Development Group. In still other embodiments, the database 120 may be a custom-designed database based on an open source database, such as the MYSQL family of freely available database products distributed by Oracle Corporation of Redwood City, CA. In other embodiments, examples of databases include, without limitation, structured storage (e.g., NoSQL-type databases and BigTable databases), H Base databases distributed by The Apache Software Foundation of Forest Hill, MD, MongoDB databases distributed by ioGen, Inc., of NewYork, NY, an AWS DynamoDB distributed by Amazon Web Services and Cassandra databases distributed by The Apache Software Foundation of Forest Hill, MD. In further embodiments, the database 120 may be any form or type of database.

Referring now to FIG. 1B, a block diagram depicts one embodiment of a system 100 for biometrics-based secure data recovery, which includes functionality for encrypting a data item.

Referring now to FIG. 1C, a block diagram depicts one embodiment of a single factor storage system, in which no additional credentials are needed other than biometrics reading of a physical characteristic of a user. The key generator 105 described above may be provided by or in communication with a noise-resistant feature transformation and hashing module 111 as shown in FIG. 1C.

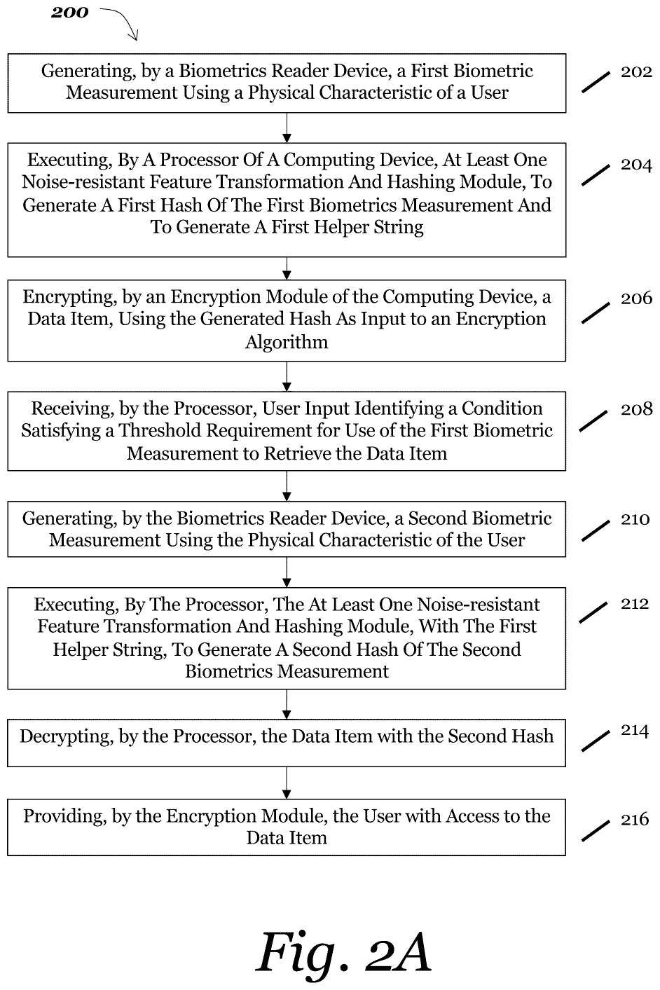

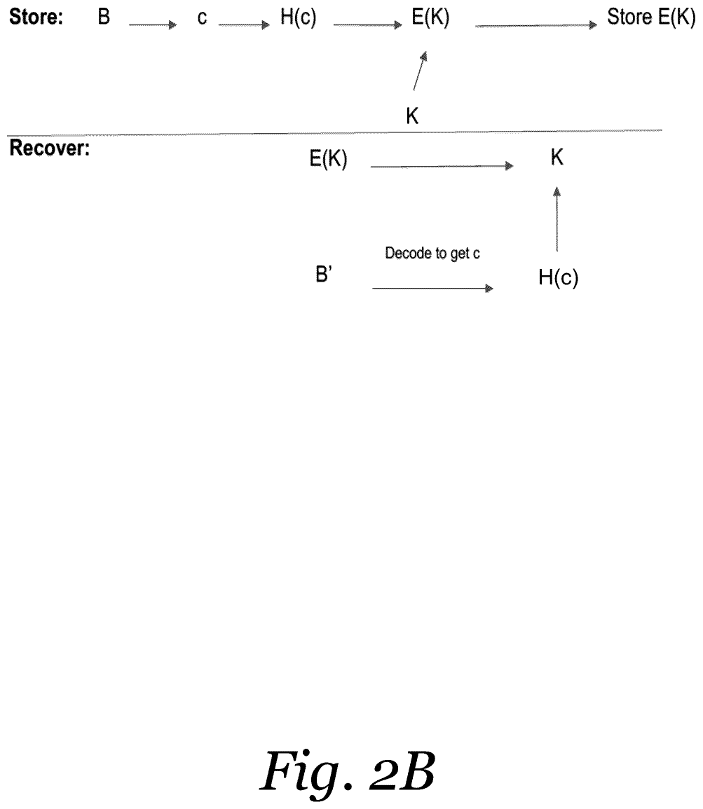

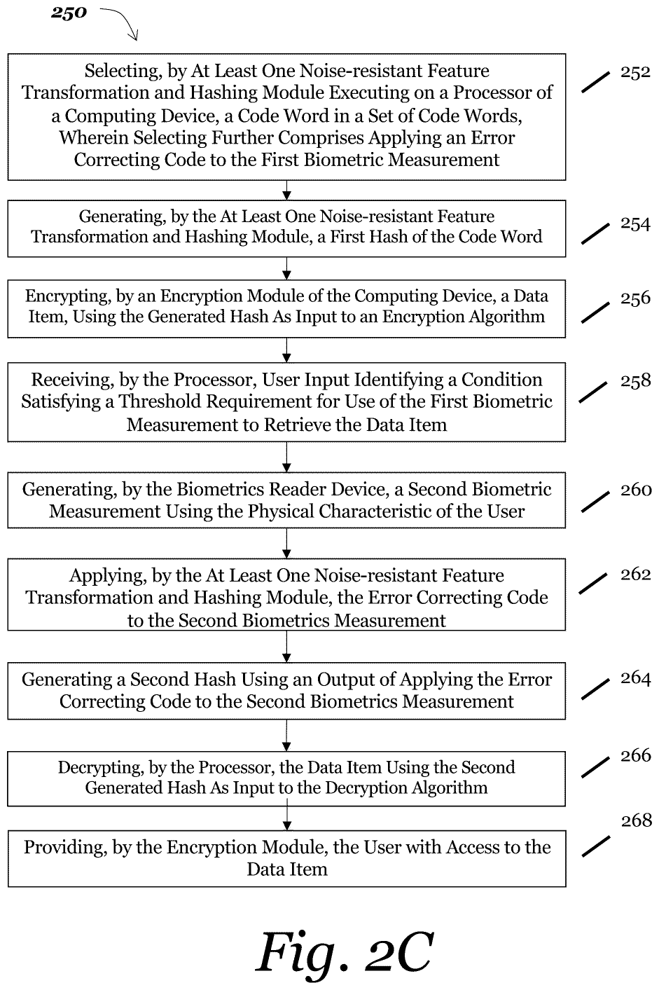

Referring now to FIG. 2A, and in connection with FIG. 1A, a flow diagram depicts one embodiment of a method 200 for biometrics-based secure data recovery using a generated helper string. In brief overview, the method 200 includes generating, by a biometrics reader device, a first biometric measurement using a physical characteristic of a user (202). The method 200 includes executing, by a processor of a computing device, at least one noise-resistant feature transformation and hashing module, to generate a first hash of the first biometrics measurement and to generate a first helper string (204). The method 200 includes encrypting, by an encryption module of the computing device, a data item, using the generated hash as input to an encryption algorithm (206). The method 200 includes receiving, by the processor, user input identifying a condition satisfying a threshold requirement for use of the first biometric measurement to retrieve the data item (208). The method 200 includes generating, by the biometrics reader device, a second biometric measurement using the physical characteristic of the user (210). The method 200 includes executing, by the processor, the at least one noise-resistant feature transformation and hashing module, with the first helper string, to generate a second hash of the second biometrics measurement (212). The method 200 includes decrypting, by the processor, the data item using the second generated hash as input to the decryption algorithm (214). The method 200 includes providing, by the encryption module, the user with access to the data item (216).

Referring now to FIG. 2A, in greater detail, the method 200 includes generating, by a biometrics reader device, a first biometric measurement using a physical characteristic of a user (202). The biometric measurement may be a measurement of a physical characteristic of, for example, a fingerprint, an iris, a vein, a voice, or a face. The biometric measurement may be a measurement of multiple different physical characteristics. The biometric measurement may include multiple measurements of a single physical characteristics (e.g., an average of three readings of a fingerprint).

The method 200 includes executing, by a processor of a computing device, at least one noise-resistant feature transformation and hashing module, to generate a first hash of the first biometrics measurement and to generate a first helper string (204). As will be understood by those of skill in the art, the definition of ‘hash’, as used throughout this document, is any algorithm that obfuscates the original input in a way such that it is extremely difficult to recover the original input given the obfuscated output. It is not limited to any particular, or standard, computational function.

In some embodiments, the processor 1211 does not store the first biometric measurement, nor the first hash. The processor 121 may store the helper string, either locally or in a database 120 accessible to the processor. The processor 121 may store the encrypted data item, either locally or in a database accessible to the processor.

The method 200 includes encrypting, by an encryption module of the computing device, a data item, using the generated hash as input to an encryption algorithm (206). As indicated above, the encryptor 107 may receive the data item to be encrypted (e.g., the secret 109), either directly from the user or indirectly from the computing device 102. The encryptor 107 may encrypt the data item.

The method 200 includes receiving, by the processor, user input identifying a condition satisfying a threshold requirement for use of the first biometric measurement to retrieve the data item (208). In some embodiments, the user input occurs when a user clicks on or otherwise selects a user interface element in a user interface to indicate that the condition satisfying the threshold requirement occurred. The user input may specify that the user wishes to recover the data item because of having lost the original data item. The user input may specify that the user wishes to recover the data item because of having lost a physical device on which the user had previously stored the data item. The user input may specify that the user wishes to recover the data item because another user who previously authorized the user to access the data item is now deceased. Users may configure different types of user input to provide for different conditions.

The method 200 includes generating, by the biometrics reader device, a second biometric measurement using the physical characteristic of the user (210). By way of example, without limitation, the user may place their finger on a fingerprint reader. In some embodiments, generating the second biometric measurement occurs on a second biometrics reader. By way of example, if the user no longer has access to the biometrics reader device that generated the first biometric measurement, the user may use a second biometrics reader device to generate the second biometric measurement. Since the physical characteristic the second biometrics reader device measures belongs to the same user, the two measurements should be substantially similar.

The method 200 includes executing, by the processor, the at least one noise-resistant feature transformation and hashing module, with the first helper string, to generate a second hash of the second biometrics measurement (212). The executing of at least one noise-resistant feature transformation and hashing module may include registering the first biometric measurement to a nearest code word in a code universe accessible to the noise-resistant feature transformation and hashing module. By way of example and without limitation, the method 200 may include accessing a data structure (e.g., vectors, matrices, polynomials, or other data structures) that stores a plurality of code words (e.g., strings for use in error-correction coding, separate from helper strings) and identifying one of the plurality of code words that has a distance to the first biometric measurement less than a pre-specified threshold distance. The method may further include using the first helper string to compensate for the distance between a hash of a biometric measurement (either the first hash or the second hash) and the identified code word. As will be understood by those of skill in the art, the helper string may be used with a subsequent biometric measurement to generate a second hash that will be identical to the first hash as long as the second biometric measurement is also less than the pre-specified threshold distance to the identified code word (as would be the case of the same user presented the same physical characteristic for reading by the biometrics reader device or a substantially similar biometrics reader device).

The method 200 includes decrypting, by the processor, the data item with the second hash (214). In some embodiments, if the second hash, generated based on both the second biometric measurement and the first helper string, is not an exact match for the first hash, then when the processor 121 attempts to decrypt the data item with the second hash, the decryption process will fail. If the second hash and the first hash do match, then the processor 121 does decrypt the data item with the second hash.

The method 200 includes providing, by the encryption module, the user with access to the data item (216). By way of example, the encryptor 107 may transmit the data item to the user.

Referring now to FIG. 1D is a block diagram of one embodiment of a system providing functionality for single factor recovery. In one embodiment, the method for biometrics-based secure data recovery uses a fingerprint error correction string, which may be referred to as a codeword in C, (separate from the helper string) which may be an (n,k,d) BCH code with length n, dimension k, distance d and parity check matrix G, chosen to be small enough such that different individuals will not be identified as the same person, but large enough to allow for some fuzziness in how each individual presents their biometric at each reading. In this embodiment, c,c′ are codewords in C, B is the enrolled biometric (never stored), B′ is the re-presented biometric (never stored), e,e′ are the respective error vectors corresponding to B and B′ wrt C, h=syn(B) is the ‘helper string’, where syn(B)=GB is the syndrome of B. Note that h does not leak substantial information about B since it is only telling us how far B is from some codeword in C. If one chooses the dimension k of C to be large enough, C will still be left with sufficient entropy/security. If an individual presents a new biometric B′ and it is close enough to the enrolled biometric B to decode to the same codeword c, then the method applies the helper string h to reproduce B from B′. This will not work if a different biometric B′ is presented that is sufficiently different from B:
By definition B=c+e and B′=c+e′
For enrolled biometric B, compute h=syn(B)=GB=G(c+e)=Gc+Ge=o+Ge=Ge
For new biometric B′, compute h+syn(B′)=GB+GB′=Ge+Ge′=G(e+e′)
Use syndrome decoding to get error vector v=e+e′
Compute B′+v=B′+e+e′=c′+e=c+e=B if c=c′ Referring now to FIG. 1E is a block diagram depicting one embodiment of comparing different codes to an enrolled code.

Referring now to FIG. 2B, a flow diagram depicts another embodiment of the method shown in FIG. 2A.

Referring now to FIG. 1F is a flow diagram depicting an embodiment of a key storage and recovery process using a single biometric in which H is a one-way cryptographic hash function (e.g., SHA-256), E is a symmetric encryption algorithm (e.g., AES), and K is a private key used for a public key encryption algorithm (e.g. RSA), but could also represent other data items including sensitive data, such as a file of accounts and passwords, legal documents, and so on. In some embodiments, therefore, as indicated in FIG. 1F and in FIG. 2C, the methods and systems described herein provide functionality for biometrics-based secure data recovery without requiring the use of the helper string.

Referring now to FIG. 2C, a flow diagram depicts one embodiment of a method 250 for generating, by a biometrics reader device, a first biometric measurement using a physical characteristic of a user, without using the helper string. The method 250 includes selecting, by at least one noise-resistant feature transformation and hashing module executing on a processor of a computing device, a code word in a set of code words, wherein selecting further comprises applying an error correcting code to the first biometric measurement (252). The method 250 includes generating, by the at least one noise-resistant feature transformation and hashing module, a first hash of the code word (254). The method 250 includes encrypting, by an encryption module of the computing device, a data item, using the generated hash as input to an encryption algorithm (256). The method 250 includes receiving, by the processor, user input identifying a condition satisfying a threshold requirement for use of the first biometric measurement to retrieve the data item (258). The method 250 includes generating, by the biometrics reader device, a second biometric measurement using the physical characteristic of the user (260). The method 250 includes applying, by the at least one noise-resistant feature transformation and hashing module, the error correcting code to the second biometrics measurement (262). The method 250 includes generating a second hash using an output of applying the error correcting code to the second biometrics measurement (264). The method 250 includes decrypting, by the processor, the data item using the second generated hash as input to the decryption algorithm (266). The method 250 includes providing, by the encryption module, the user with access to the data item (268).

In the event that the application of the error correcting code to the second biometrics measurement results in generation of a second code word that is different from the code word received when applying the error correcting code to the first biometrics measurement, then the second hash will differ from the first hash and the system will not be able to decrypt the data item with the second hash. Since the method does not include generation of a helper string or the application of the helper string in attempting to determine the distance between an error correcting code and the biometrics measurement, the system may provide less flexibility but also provides additional security for the user and an additional layer of privacy.

The methods and systems described herein may provide functionality for a key recovery process using one of a set of authentication factors (or, as indicated above, recovery of any data item). In such an example, B={B1, . . . , Bt} be a set of t distinct authentication factors, which can consist of multiple biometrics from one or more individuals, PINs, passwords, passphrases, hardware keys, etc., only one of the Bi∈B is required for key recovery; this can be viewed as a disaster recovery mode, used if some subset of the factors are lost by the user.

The methods and systems described herein may provide functionality for a key recovery processing using some or all of a set of factors (or, as indicated above, recovery of any data item). In such an example, Let B={B1, . . . , Bt} be a set oft distinct authentication factors, which can consist of multiple biometrics from one or more individuals, PINs, passwords, passphrases, hardware keys, etc.; in this scenario, all of the factors from some subset AgB (with A containing at least two factors) are required for key recovery. This can be viewed as a variation of multi-factor authentication and/or “two-person control”. Biometrics may be used because they are tied directly to an individual, and in cases where recovery will not be performed often, biometrics are less likely to be lost by the users.

The methods and systems described herein may provide functionality allowing users to specify one or more profiles for use with the systems. An identification of a user profile may be referred to herein as a persona. As an example, a user may specify one profile to use when accessing the systems for use when working and may specify a second profile to use when accessing the systems for in a personal capacity, for example, when the user wants to use the same biometric (e.g., the same fingerprint) to gain access to a plurality of digital resources without using the same identifier across all digital resources, which could compromise privacy. Since a single biometric identifier cannot typically be changed to reliably reproduce multiple identifiers, conventional approaches do not provide a solution for such a scenario. However, through the use of a persona, the methods and systems described herein provide functionality for addressing this scenario, where the persona may be one or more pieces of digital data that a user has chosen to enumerate the scope of a particular asset or asset class they wish to gain access to—for example, an employee could use a work email address as a persona when seeking to gain access to digital resources controlled by an employer and a personal email address as a persona for accessing other digital resources. The persona need not be unique to the user—for example, the user may use the public key of an employer in their persona as an employee—nor does the persona need to be comprised of only one factor; the persona need only be unique to the asset or class of assets that will be accessed by the user when using that persona. This functionality may be combined with the functionality for providing key recovery processes using one of a set of authentication factors and/or with the functionality for providing key recovery processes using a plurality of authentication factors.

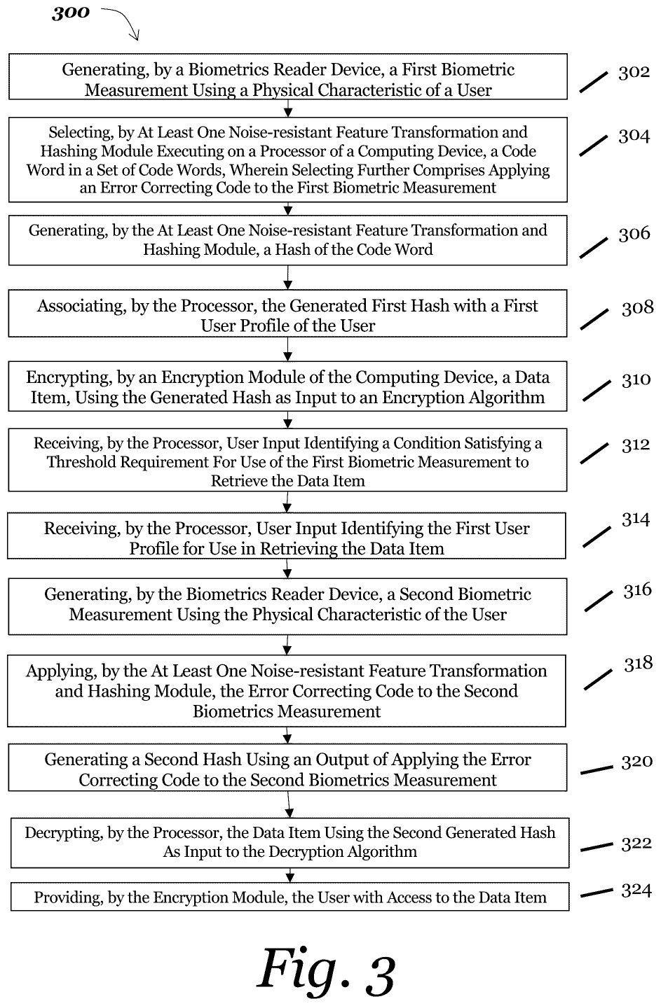

Therefore, referring now to FIG. 3, a flow diagram depicts one embodiment of a method 300 for biometrics-based secure data recovery by a user with at least one profile. The method 300 includes generating, by a biometrics reader device, a first biometric measurement using a physical characteristic of a user (302). The method 300 includes selecting, by at least one noise-resistant feature transformation and hashing module executing on a processor of a computing device, a code word in a set of code words, wherein selecting further comprises applying an error correcting code to the first biometric measurement (304). The method 300 includes generating, by the at least one noise-resistant feature transformation and hashing module, a hash of the code word (306). The method 300 includes associating, by the processor, the generated first hash with a first user profile of the user (308). The method 300 includes encrypting, by an encryption module of the computing device, a data item, using the generated hash as input to an encryption algorithm (310). The method 300 includes receiving, by the processor, user input identifying a condition satisfying a threshold requirement for use of the first biometric measurement to retrieve the data item (312). The method 300 includes receiving, by the processor, user input identifying the first user profile for use in retrieving the data item (314). The method may include comparing, by the processor, the user input identifying the first user profile with the first user profile associated with the generated first hash and confirming that the two profiles are substantially similar. The method may include determining, by the processor, that the user providing the user input identifying the first user profile is identified in the first user profile as a user authorized to access the data item. The method may include determining, by the processor, that the user providing the user input identifying the first user profile is identified in a data structure associated with the first user profile as a user authorized to access the data item. The method 300 includes generating, by the biometrics reader device, a second biometric measurement using the physical characteristic of the user (316). The method 300 includes applying, by the at least one noise-resistant feature transformation and hashing module, the error correcting code to the second biometrics measurement (318). The method 300 includes generating a second hash using an output of applying the error correcting code to the second biometrics measurement (320). The method 300 includes decrypting, by the processor, the data item using the second generated hash as input to the decryption algorithm (322). The method 300 includes providing, by the encryption module, the user with access to the data item (324). As indicated above, the method may make it optional to use the helper string.

Although the methods described above refer to the use of a single factor in authenticating a user (the biometric measurement), in some embodiments, the methods and systems described herein provide functionality for incorporating two or more factors in authenticating the user. As an example, and without limitation, the user may need to provide a security credential as well as biometric measurement.

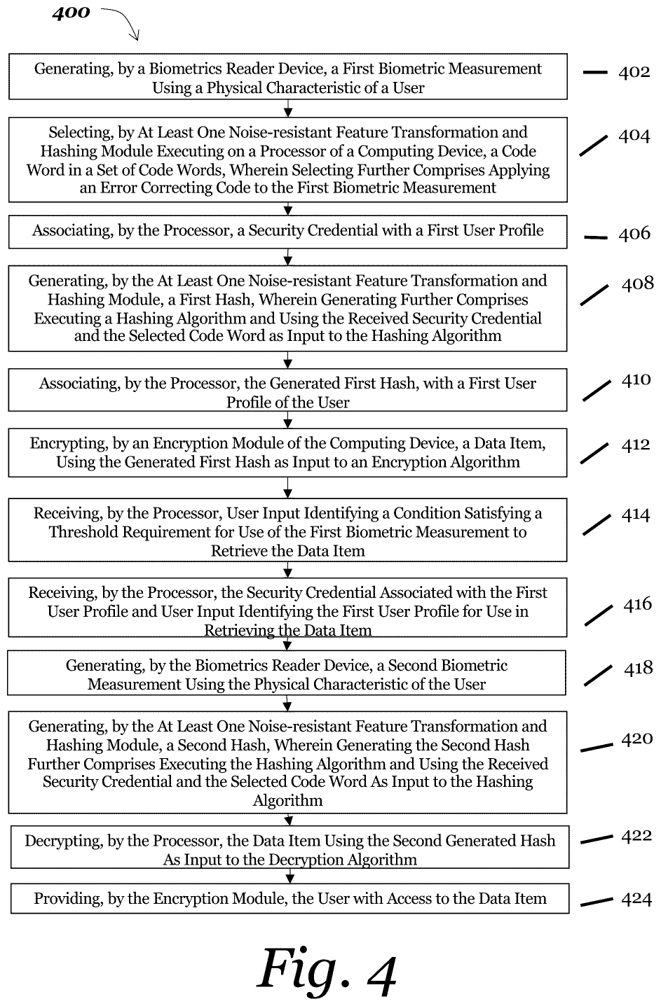

Referring now to FIG. 4, a flow diagram depicts one embodiment of a method for multi-factor, biometrics-based, secure data recovery by a user with at least one profile. The method 400 includes generating, by a biometrics reader device, a first biometric measurement using a physical characteristic of a user (402). The method 400 includes selecting, by at least one noise-resistant feature transformation and hashing module executing on a processor of a computing device, a code word in a set of code words, wherein selecting further comprises applying an error correcting code to the first biometric measurement (404). The method 400 includes associating, by the processor, a security credential with a first user profile (406). The method 400 includes generating, by the at least one noise-resistant feature transformation and hashing module, a first hash, wherein generating further comprises executing a hashing algorithm and using the received security credential and the selected code word as input to the hashing algorithm (408). The method 400 includes associating, by the processor, the generated first hash, with a first user profile of the user (410). The method 400 includes encrypting, by an encryption module of the computing device, a data item, using the generated first hash as input to an encryption algorithm (412). The method 400 includes receiving, by the processor, user input identifying a condition satisfying a threshold requirement for use of the first biometric measurement to retrieve the data item (414). The method 400 includes receiving, by the processor, the security credential associated with the first user profile and user input identifying the first user profile for use in retrieving the data item (416). The method 400 includes generating, by the biometrics reader device, a second biometric measurement using the physical characteristic of the user (418). In such a method, the user requesting access to the data item must therefore provide both a security credential that matches a security credential previously associated with the first user profile and used in generating the first hash and must provide the biometric measurement that was used in selecting a code word used in generating the first hash. The method 400 includes generating, by the at least one noise-resistant feature transformation and hashing module, a second hash, wherein generating the second hash further comprises executing the hashing algorithm and using the received security credential and the selected code word as input to the hashing algorithm (420). The method 400 includes decrypting, by the processor, the data item using the second generated hash as input to the decryption algorithm (422). The method 400 includes providing, by the encryption module, the user with access to the data item (424). The method may make it optional to use the helper string.

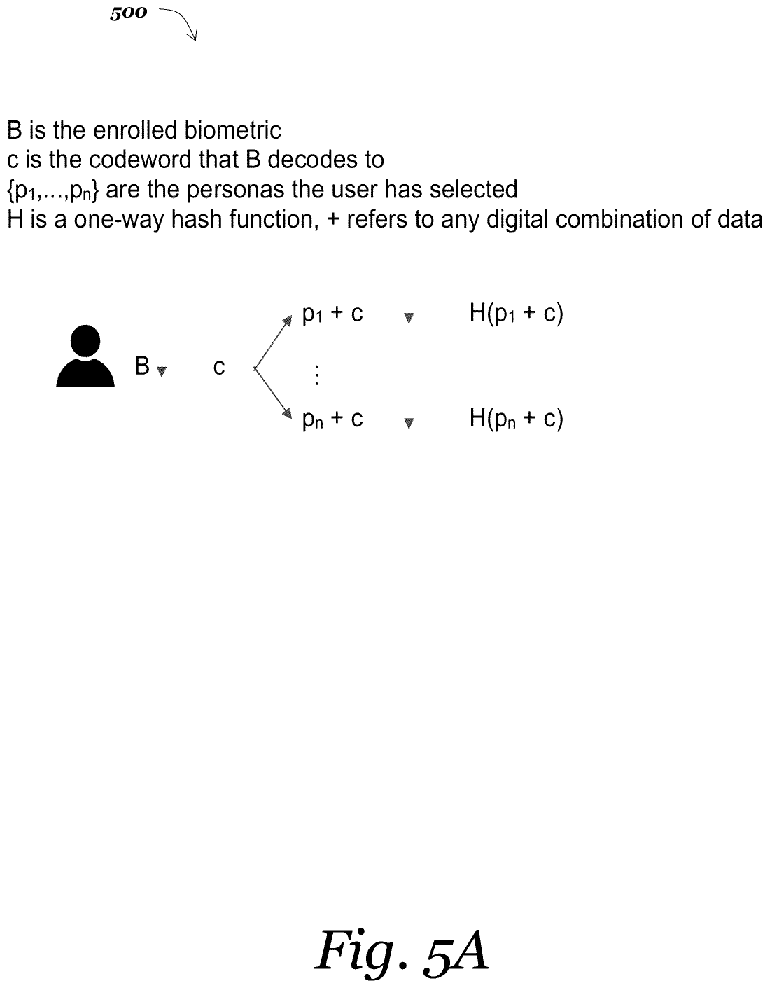

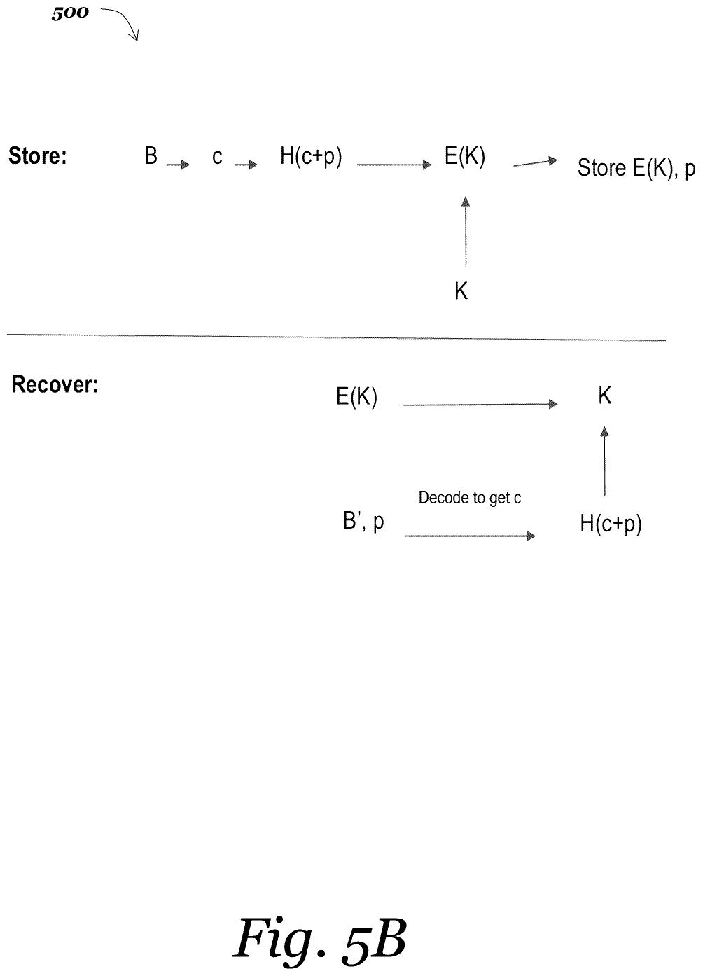

Referring now to FIG. 5A, a block diagram depicts one embodiment of a method 500 for using a biometric measurement with a persona, wherein B is the enrolled biometric, c is the codeword that B decodes to, {p1, . . . , pn} are the personas the user has selected, and H is a one-way hash function, + refers to any digital combination of data. As shown in FIG. 5A, a key has been generated from the combination of a biometric and a persona. This key can be used in data recovery or in general as a unique key in cryptographic or authentication applications.

Referring now to FIG. 5B is a flow diagram depicts one embodiment of key recovery method 500 using a single biometric and a persona p. As shown in FIG. 5B, in one embodiment, the methods described herein may include a step of receiving user input identifying a condition satisfying a threshold requirement for use of the first biometric measurement to retrieve the data item. Therefore, in some embodiments, the methods described herein for retrieving protected data may only be executed upon indication that a trigger event—or condition satisfying a threshold requirement—has occurred. As one example, a user may authenticate using the methods and systems described herein to recover access to a secure, recoverable cryptocurrency wallet when the user indicates they have lost their credentials for accessing the wallet. As another example, a user may authenticate using the methods and systems described herein to recover access to secured documents, accounts, passwords, and other digital assets when the user has lost those credentials. As still another example, a user may authenticate using the methods and systems described herein to recover lost access to passkeys using a platform-agnostic method, where the passkeys are multi-device fast ID online credentials. As a further example, a will or testamentary instrument may specify that a pre-determined survivor who was registered with the system at the time of execution of the will or testamentary instrument, or prior to decease of the decedent, may recover and use credentials of the decedent upon authentication of the survivor by the methods and systems described herein; in such an example, the system may optionally require access to a digital copy of a death certificate or an indication that the decedent is in fact deceased.

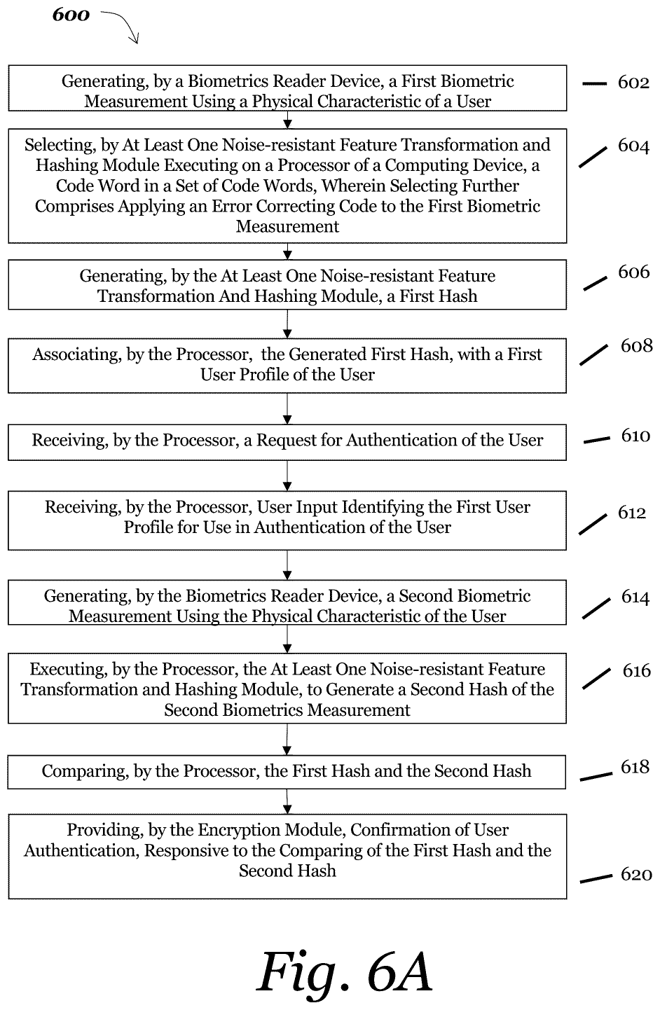

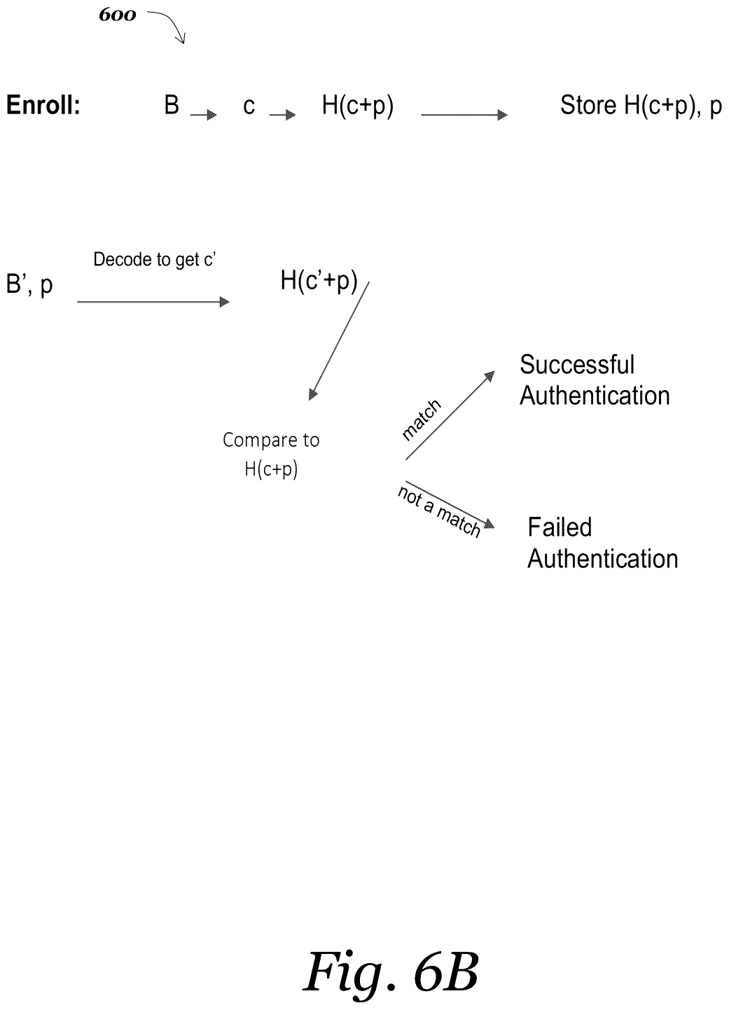

The methods and systems described herein may provide functionality allowing users to authenticate in order to gain access to data items. The methods and systems described herein may also or alternatively provide functionality allowing users to authenticate in order to gain access to secured systems instead of specific data items. Therefore, referring now to FIG. 6A, a flow diagram depicts one embodiment of a method 600 for biometrics-based authentication by a user with at least one profile. The method 600 includes generating, by a biometrics reader device, a first biometric measurement using a physical characteristic of a user (602). The method 600 includes selecting, by at least one noise-resistant feature transformation and hashing module executing on a processor of a computing device, a code word in a set of code words, wherein selecting further comprises applying an error correcting code to the first biometric measurement (604). The method 600 includes generating, by the at least one noise-resistant feature transformation and hashing module, a first hash of the code word (606). The method 600 includes associating, by the processor, the generated first hash with a first user profile of the user (608). The method 600 includes receiving, by the processor, a request for authentication of the user (610). The method 600 includes receiving, by the processor, user input identifying the first user profile for use in authentication of the user (612). The method 600 includes generating, by the biometrics reader device, a second biometric measurement using the physical characteristic of the user (614). The method 600 includes executing, by the processor, the at least one noise-resistant feature transformation and hashing module, to generate a second hash of the second biometrics measurement (616). The method 600 includes comparing, by the processor, the first hash and the second hash (618). The method 600 includes providing, by the encryption module, confirmation of user authentication, responsive to the comparing of the first hash and the second hash (620). FIG. 6B provides a flow chart providing another description of the method 600 for performing authentication using a single biometric and a persona p.

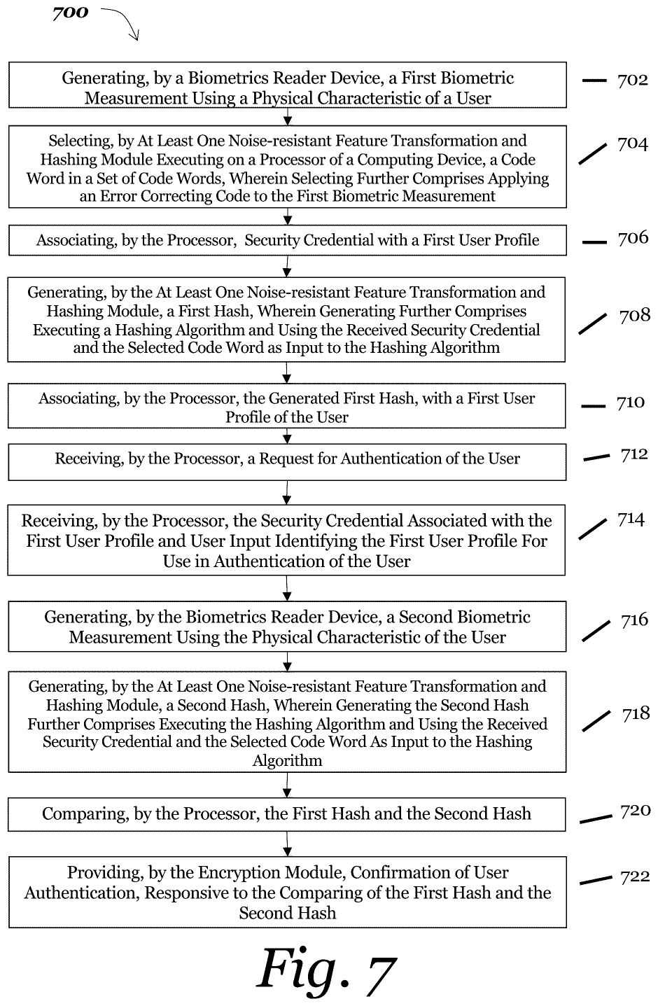

In addition to, or instead of, authenticating users without requiring the use of multiple-factor authentication (e.g., without requiring at least one security credential in addition to the use of the biometric measurements), the methods and systems described herein may provide functionality allowing users to authenticate with a single factor in order to gain access to data items while requiring multiple factors in order to authenticate the user for other purposes. Therefore, and referring now to FIG. 7, a flow diagram depicts one embodiment of a method 700 for multi-factor, biometrics-based, authentication by a user with at least one profile. The method 700 includes generating, by a biometrics reader device, a first biometric measurement using a physical characteristic of a user (702). The method 700 includes selecting, by at least one noise-resistant feature transformation and hashing module executing on a processor of a computing device, a code word in a set of code words, wherein selecting further comprises applying an error correcting code to the first biometric measurement (704). The method 700 includes associating, by the processor, a security credential with a first user profile (706). The method 700 includes generating, by the at least one noise-resistant feature transformation and hashing module, a first hash, wherein generating further comprises executing a hashing algorithm and using the received security credential and the selected code word as input to the hashing algorithm (708). The method 700 includes associating, by the processor, the generated first hash, with a first user profile of the user (710). The method 700 includes receiving, by the processor, a request for authentication of the user (712). The method 700 includes receiving, by the processor, the security credential associated with the first user profile and user input identifying the first user profile for use in authentication of the user (714). The method 700 includes generating, by the biometrics reader device, a second biometric measurement using the physical characteristic of the user (716). The method 700 includes generating, by the at least one noise-resistant feature transformation and hashing module, a second hash, wherein generating the second hash further comprises executing the hashing algorithm and using the received security credential and the selected code word as input to the hashing algorithm (718). The method 700 includes comparing, by the processor, the first hash and the second hash (720). The method 700 includes providing, by the encryption module, confirmation of user authentication, responsive to the comparing of the first hash and the second hash (722).

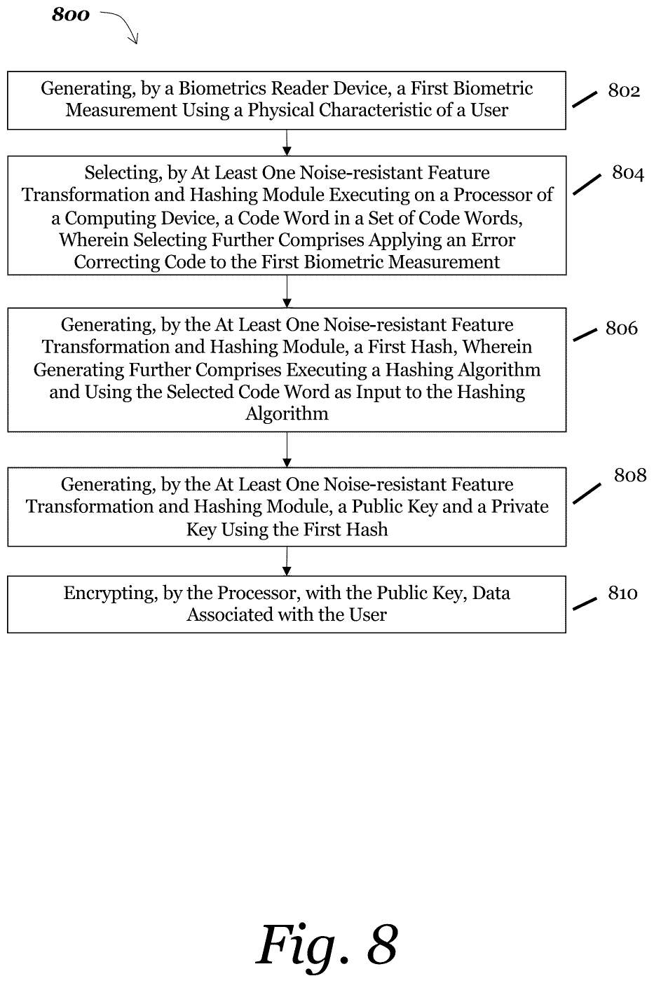

In some embodiments, the methods and systems described herein may provide functionality for generating a key pair (e.g., a public key and a private key) using a generated hash. Therefore, referring now to FIG. 8, a flow diagram depicts one embodiment of a method 800 for multi-factor, biometrics-based, secure data encryption by a user. The method 800 includes generating, by a biometrics reader device, a first biometric measurement using a physical characteristic of a user (802). The method 800 includes selecting, by at least one noise-resistant feature transformation and hashing module executing on a processor of a computing device, a code word in a set of code words, wherein selecting further comprises applying an error correcting code to the first biometric measurement (804). generating, by the at least one noise-resistant feature transformation and hashing module, a first hash, wherein generating further comprises executing a hashing algorithm and using the selected code word as input to the hashing algorithm (806). The method 800 includes generating, by the at least one noise-resistant feature transformation and hashing module, a public key and a private key, using the first hash (808). The method 800 includes encrypting data associated with the user with the public key (810).

In some embodiments, the method 800 may further execute steps for decryption of data with a subsequently generated second private key, deterministically recreated using the same hash. That is, the method may further include: receiving, by the processor, user input identifying a condition satisfying a threshold requirement for use of the first biometric measurement to retrieve the data item; generating, by the biometrics reader device, a second biometric measurement using the physical characteristic of the user; generating, by the at least one noise-resistant feature transformation and hashing module, a second hash, wherein generating the second hash further comprises executing the hashing algorithm and using the selected code word as input to the hashing algorithm; generating, by the at least one noise-resistant feature transformation and hashing module, a second public key and a second private key, using the second hash; decrypting, by the processor, the data item with the second private key; and providing, by the encryption module, the user with access to the decrypted data item.

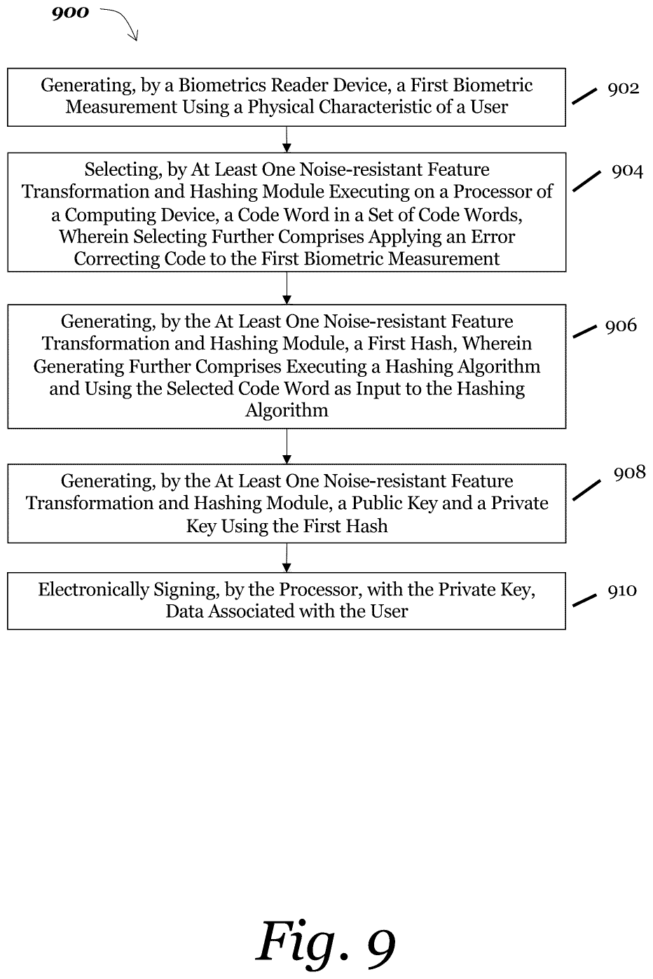

Referring now to FIG. 9, a flow diagram depicts one embodiment of a method 900 for multi-factor, biometrics-based, secure data signature by a user. The method 900 includes generating, by a biometrics reader device, a first biometric measurement using a physical characteristic of a user (902). The method 900 includes selecting, by at least one noise-resistant feature transformation and hashing module executing on a processor of a computing device, a code word in a set of code words, wherein selecting further comprises applying an error correcting code to the first biometric measurement (904). The method 900 includes generating, by the at least one noise-resistant feature transformation and hashing module, a first hash, wherein generating further comprises executing a hashing algorithm and using the selected code word as input to the hashing algorithm (906). The method 900 includes generating, by the at least one noise-resistant feature transformation and hashing module, a public key and a private key, using the first hash (908). The method 900 includes electronically signing, with the private key, data associated with the user (910). In this embodiment, the public key and private key used for digital signature may be used as a passkey in fast ID online protocols.

The method 900 may include receiving, by the processor, user input identifying a condition satisfying a threshold requirement for use of the first biometric measurement to verify authenticity of a second data item associated with the user; generating, by the biometrics reader device, a second biometric measurement using the physical characteristic of the user; generating, by the at least one noise-resistant feature transformation and hashing module, a second hash, wherein generating the second hash further comprises executing the hashing algorithm and using the selected code word as input to the hashing algorithm; generating, by the at least one noise-resistant feature transformation and hashing module, a second private key, using the second hash; electronically signing, with the second private key, the second data item; and verifying the authenticity of the signed second data item using the first public key.

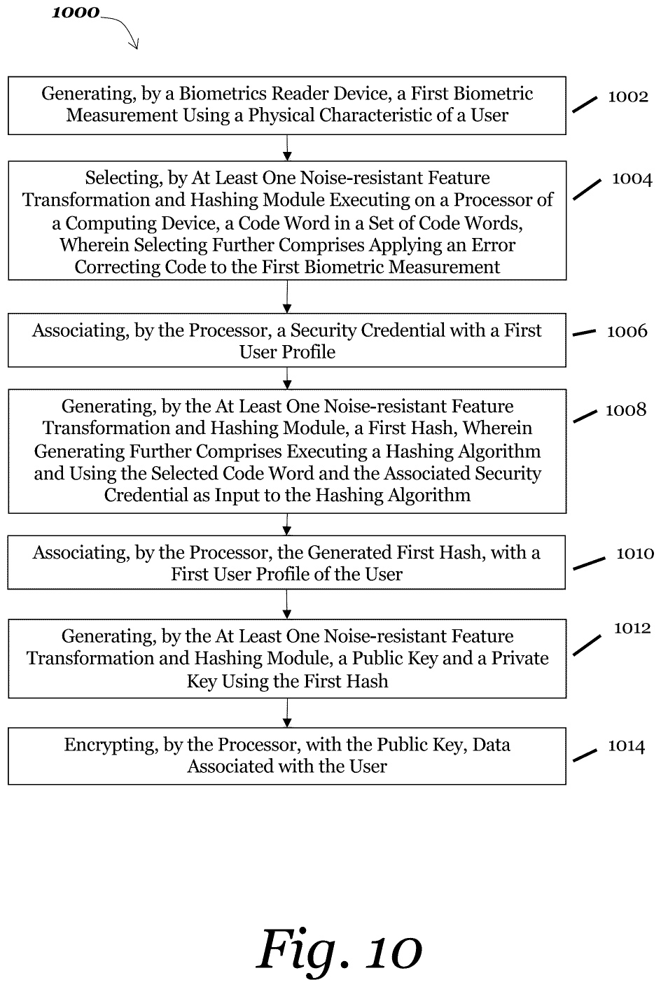

The methods and systems described herein may include methods that combine the approaches from different embodiments described above. For example, in addition to generating a public key and private key using a hash generated based on biometric measurements of a physical characteristics of a user, a method may associate the generated hash with a first profile of the user and with a security credential associated with the first profile. Therefore, referring to FIG. 10, a flow diagram depicts one embodiment of a method moo for generating, by a biometrics reader device, a first biometric measurement using a physical characteristic of a user (1002). The method moo includes selecting, by at least one noise-resistant feature transformation and hashing module executing on a processor of a computing device, a code word in a set of code words, wherein selecting further comprises applying an error correcting code to the first biometric measurement (1004). The method moo includes associating, by the processor, a security credential with a first user profile (1006). The method moo includes generating, by the at least one noise-resistant feature transformation and hashing module, a first hash, wherein generating further comprises executing a hashing algorithm and using the selected code word and the associated security credential as input to the hashing algorithm (1008). The method moo includes associating, by the processor, the generated first hash, with a first user profile of the user (1010). The method moo includes generating, by the at least one noise-resistant feature transformation and hashing module, a public key and a private key, using the first hash (1012). The method moo includes encrypting, by the processor, with the public key, data associated with the user (1014). The method may further include receiving, by the processor, user input identifying a condition satisfying a threshold requirement for use of the first biometric measurement to retrieve the data item; receiving, by the processor, the security credential associated with the first user profile and user input identifying the first user profile for use in retrieving the data item; generating, by the biometrics reader device, a second biometric measurement using the physical characteristic of the user; generating, by the at least one noise-resistant feature transformation and hashing module, a second hash, wherein generating the second hash further comprises executing the hashing algorithm and using the received security credential and the selected code word as input to the hashing algorithm; generating, by the at least one noise-resistant feature transformation and hashing module, a second public key and a second private key, using the second hash; decrypting, by the processor, the data item with the second private key; and providing, by the encryption module, the user with access to the data item.

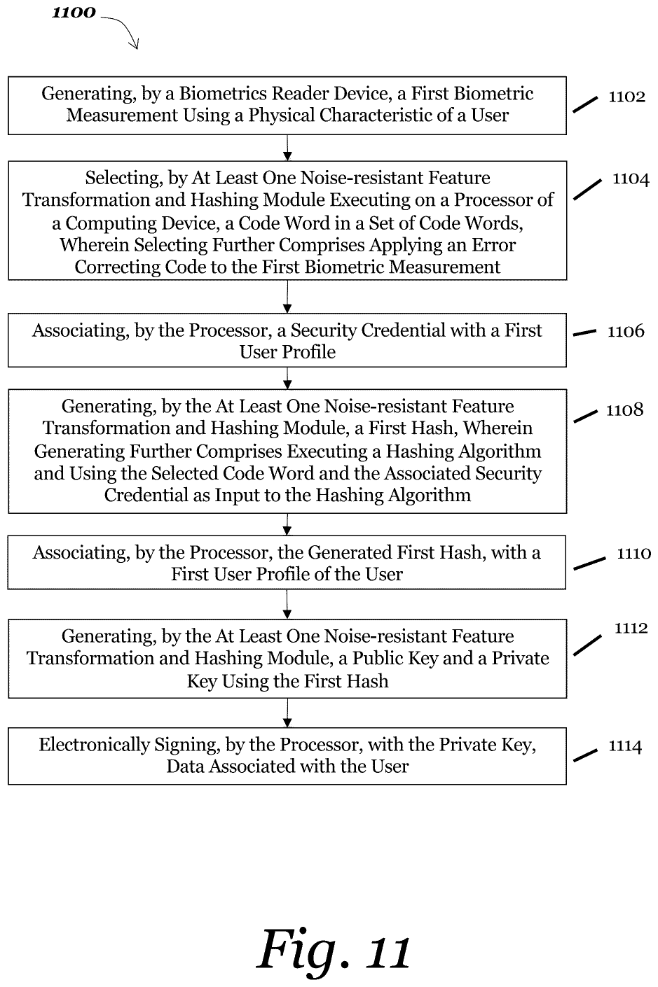

Referring now to FIG. 11, a flow diagram depicts one embodiment of a method 1100, including may generating, by a biometrics reader device, a first biometric measurement using a physical characteristic of a user (1102). The method 1100 includes selecting, by at least one noise-resistant feature transformation and hashing module executing on a processor of a computing device, a code word in a set of code words, wherein selecting further comprises applying an error correcting code to the first biometric measurement (1104). The method 1100 includes associating, by the processor, a security credential with a first user profile (1106). The method 1100 includes generating, by the at least one noise-resistant feature transformation and hashing module, a first hash, wherein generating further comprises executing a hashing algorithm and using the selected code word and the associated security credential as input to the hashing algorithm (1108). The method 1100 includes associating, by the processor, the generated first hash, with a first user profile of the user (1110). The method 1100 includes generating, by the at least one noise-resistant feature transformation and hashing module, a public key and a private key, using the first hash (1112). The method 1100 includes electronically signing, with the private key, data associated with the user (1114).

In some embodiments, the systems described herein include non-transitory, computer-readable medium comprising computer program instructions tangibly stored on the non-transitory computer-readable medium, wherein the instructions are executable by at least one processor to perform each of the steps of the methods described above.

It should be understood that the systems described above may provide multiple ones of any or each of those components and these components may be provided on either a standalone machine or, in some embodiments, on multiple machines in a distributed system. The phrases ‘in one embodiment,’ in another embodiment,′ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The terms “A or B”, “at least one of A or/and B”, “at least one of A and B”, “at least one of A or B”, or “one or more of A or/and B” used in the various embodiments of the present disclosure include any and all combinations of words enumerated with it. For example, “A or B”, “at least one of A and B” or “at least one of A or B” may mean (1) including at least one A, (2) including at least one B, (3) including either A or B, or (4) including both at least one A and at least one B.

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, Python, Rust, Go, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, and so on.

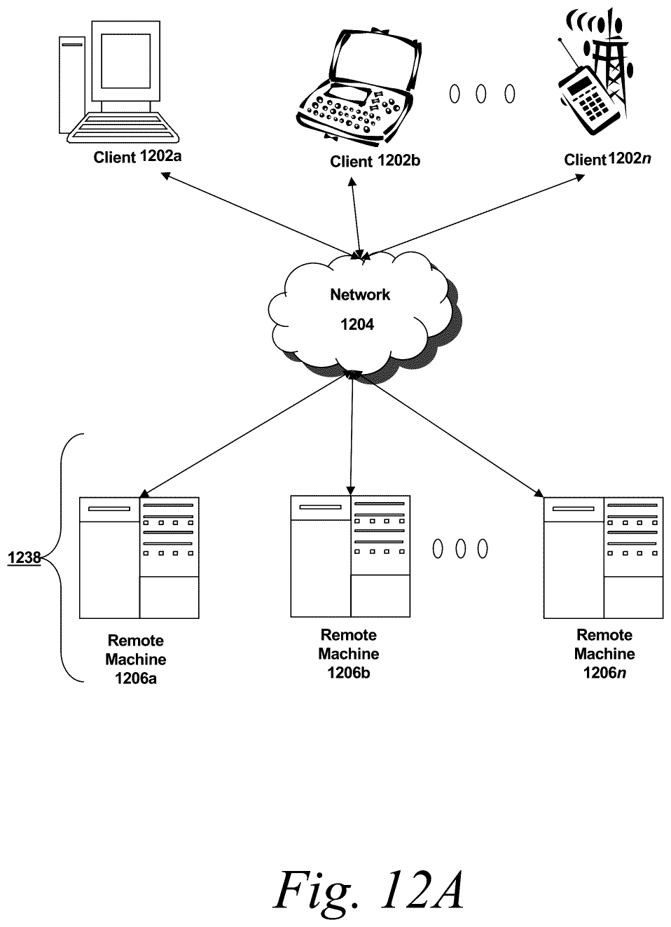

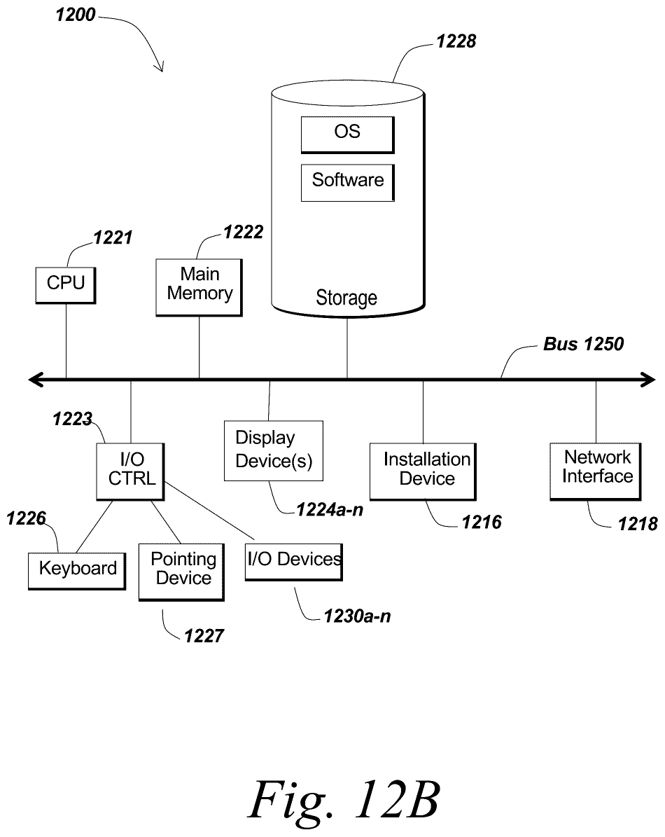

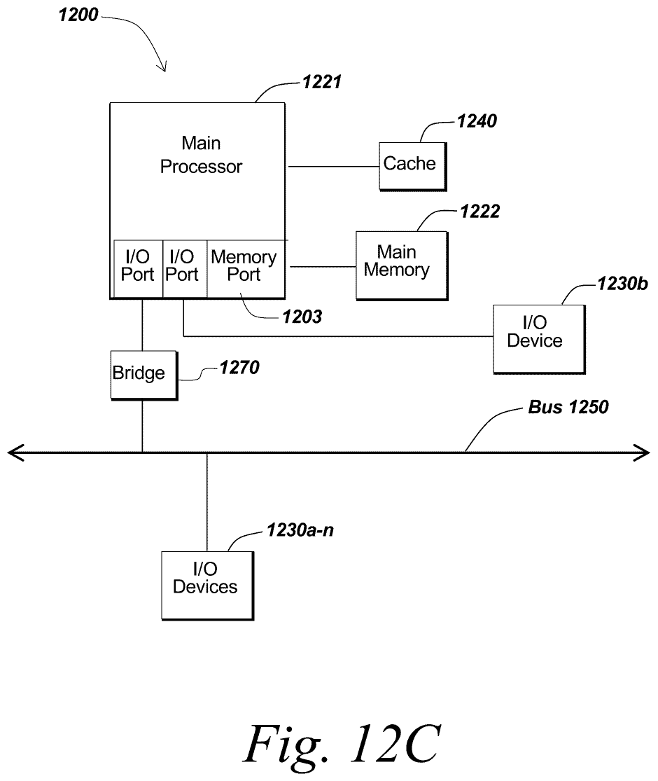

Referring now to FIGS. 12A, 12B, and 12C, block diagrams depict additional detail regarding computing devices that may be modified to execute novel, non-obvious functionality for implementing the methods and systems described above.

Referring now to FIG. 12A, an embodiment of a network environment is depicted. In brief overview, the network environment comprises one or more clients 1202a-1202n (also generally referred to as local machine(s) 1202, client(s) 1202, client node(s) 1202, client machine(s) 1202, client computer(s) 1202, client device(s) 1202, computing device(s) 1202, endpoint(s) 1202, or endpoint node(s) 1202) in communication with one or more remote machines 1206a-1206n (also generally referred to as server(s) 1206 or computing device(s) 1206) via one or more networks 1204.

Although FIG. 12A shows a network 1204 between the clients 1202 and the remote machines 1206, the clients 1202 and the remote machines 1206 may be on the same network 1204. The network 1204 can be a local area network (LAN), such as a company Intranet, a metropolitan area network (MAN), or a wide area network (WAN), such as the Internet or the World Wide Web. In some embodiments, there are multiple networks 1204 between the clients 1202 and the remote machines 1206. In one of these embodiments, a network 1204′ (not shown) may be a private network and a network 1204 may be a public network. In another of these embodiments, a network 1204 may be a private network and a network 1204′ a public network. In still another embodiment, networks 1204 and 1204′ may both be private networks. In yet another embodiment, networks 1204 and 1204′ may both be public networks.

The network 1204 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, a wireline network, an Ethernet, a virtual private network (VPN), a software-defined network (SDN), a network within the cloud such as AWS VPC (Virtual Private Cloud) network or Azure Virtual Network (VNet), and a RDMA (Remote Direct Memory Access) network. In some embodiments, the network 1204 may comprise a wireless link, such as an infrared channel or satellite band. The topology of the network 1204 may be a bus, star, or ring network topology. The network 1204 may be of any such network topology as known to those ordinarily skilled in the art capable of supporting the operations described herein. The network 1204 may comprise mobile telephone networks utilizing any protocol or protocols used to communicate among mobile devices (including tablets and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 1202 and a remote machine 1206 (referred to generally as computing devices 1200 or as machines 1200) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 1202 may execute, operate or otherwise provide an application, which can be any type and/or form of software, program, or executable instructions, including, without limitation, any type and/or form of web browser, web-based client, client-server application, an ActiveX control, a JAVA applet, a webserver, a database, an HPC (high performance computing) application, a data processing application, or any other type and/or form of executable instructions capable of executing on client 1202.

In some embodiments, the system may include multiple, logically-grouped remote machines 1206. In one of these embodiments, the logical group of remote machines may be referred to as a server farm 1238. In another of these embodiments, the server farm 1238 may be administered as a single entity.

FIGS. 12B and 12C depict block diagrams of a computing device 1200 useful for practicing an embodiment of the client 1202 or a remote machine 1206. As shown in FIGS. 12B and 12C, each computing device 1200 includes a central processing unit 1221, and a main memory unit 1222. As shown in FIG. 12B, a computing device 1200 may include a storage device 1228, an installation device 1216, a network interface 1218, an I/O controller 1223, display devices 1224a-n, a keyboard 1226, a pointing device 1227, such as a mouse, and one or more other I/O devices 1230a-n. The storage device 1228 may include, without limitation, an operating system and software. As shown in FIG. 12C, each computing device 1200 may also include additional optional elements, such as a memory port 1203, a bridge 1270, one or more input/output devices 1230a-n (generally referred to using reference numeral 1230), and a cache memory 1240 in communication with the central processing unit 1221.

The central processing unit 1221 is any logic circuitry that responds to and processes instructions fetched from the main memory unit 1222. In many embodiments, the central processing unit 1221 is provided by a microprocessor unit, such as: those manufactured by Intel Corporation of Mountain View, CA; those manufactured by Motorola Corporation of Schaumburg, IL; those manufactured by Transmeta Corporation of Santa Clara, CA; those manufactured by International Business Machines of White Plains, NY; or those manufactured by Advanced Micro Devices of Sunnyvale, CA. Other examples include RISC-V processors, SPARC processors, ARM processors, and processors for mobile devices. The computing device 1200 may be based on any of these processors, or any other processor capable of operating as described herein.

Main memory unit 1222 may be one or more memory chips capable of storing data and allowing any storage location to be directly accessed by the microprocessor 1221. The main memory 1222 may be based on any available memory chips capable of operating as described herein. In the embodiment shown in FIG. 12B, the processor 1221 communicates with main memory 1222 via a system bus 1250. FIG. 12C depicts an embodiment of a computing device 1200 in which the processor communicates directly with main memory 1222 via a memory port 1203. FIG. 12C also depicts an embodiment in which the main processor 1221 communicates directly with cache memory 1240 via a secondary bus, sometimes referred to as a backside bus. In other embodiments, the main processor 1221 communicates with cache memory 1240 using the system bus 1250.

In the embodiment shown in FIG. 12B, the processor 1221 communicates with various I/O devices 1230 via a local system bus 1250. Various buses may be used to connect the central processing unit 1221 to any of the I/O devices 1230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 1224, the processor 1221 may use an Advanced Graphics Port (AGP) to communicate with the display 1224. FIG. 12C depicts an embodiment of a computing device 1200 in which the main processor 1221 also communicates directly with an I/O device 1230b via, for example, HYPERTRANSPORT, RAPIDIO, or INFINIBAND communications technology.

One or more of a wide variety of I/O devices 1230a-n may be present in or connected to the computing device 1200, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 1223 as shown in FIG. 12B. Furthermore, an I/O device may also provide storage and/or an installation medium 1216 for the computing device 1200. In some embodiments, the computing device 1200 may provide USB connections (not shown) to receive handheld USB storage devices such as the USB Flash Drive line of devices manufactured by Twintech Industry, Inc. of Los Alamitos, CA.

Referring still to FIG. 12B, the computing device 1200 may support any suitable installation device 1216, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 1200 may provide functionality for installing software over a network 1204. The computing device 1200 may further comprise a storage device, such as one or more hard disk drives or redundant arrays of independent disks, for storing an operating system and other software. Alternatively, the computing device 1200 may rely on memory chips for storage instead of hard disks.

Furthermore, the computing device 1200 may include a network interface 1218 to interface to the network 1204 through a variety of connections including, but not limited to, standard telephone lines, LAN or WAN links (e.g., 802.11, Ti, T3, 56 kb, X.25, SNA, DECNET, RDMA), broadband connections (e.g., ISDN, Frame Relay, ATM, Gigabit Ethernet, Ethernet-over-SONET), wireless connections, virtual private network (VPN) connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 1200 communicates with other computing devices via any type and/or form of gateway or tunneling protocol such as GRE, VXLAN, IPIP, SIT, ip6tnl, VTI and VTI6, IP6GRE, FOU, GUE, GENEVE, ERSPAN, Secure Socket Layer (SSL) or Transport Layer Security (TLS). The network interface 1218 may comprise a built-in network adapter, network interface card, PCMCIA network card, card bus network adapter, wireless network adapter, USB network adapter, modem, or any other device suitable for interfacing the computing device 1200 to any type of network capable of communication and performing the operations described herein.

In further embodiments, an I/O device 1230 may be a bridge between the system bus 1250 and an external communication bus, such as a USB bus, an Apple Desktop Bus, an RS-232 serial connection, a SCSI bus, a FireWire bus, a FireWire bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 1200 of the sort depicted in FIGS. 12B and 12C typically operates under the control of operating systems, which control scheduling of tasks and access to system resources. The computing device 1200 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, WINDOWS VISTA, and WINDOWS 10 all of which are manufactured by Microsoft Corporation of Redmond, WA; MAC OS manufactured by Apple Inc. of Cupertino, CA; OS/2 manufactured by International Business Machines of Armonk, NY; Red Hat Enterprise Linux, a Linux-variant operating system distributed by Red Hat, Inc., of Raleigh, NC; Ubuntu, a freely-available operating system distributed by Canonical Ltd. of London, England; CentOS, a freely-available operating system distributed by the centos.org community; SUSE Linux, a freely-available operating system distributed by SUSE, or any type and/or form of a Unix operating system, among others.

Having described certain embodiments of methods and systems for systems and methods for biometrics-based secure data encryption and data signature, it will be apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for multi-factor, biometrics-based, secure data signature by a user, the method including:
generating, by a biometrics reader device, a first biometric measurement using a physical characteristic of a user;
selecting, by at least one noise-resistant feature transformation and hashing module executing on a processor of a computing device, a code word in a set of code words, wherein selecting further comprises applying an error correcting code to the first biometric measurement;
generating, by the at least one noise-resistant feature transformation and hashing module, a first hash, wherein generating further comprises executing a hashing algorithm and using the code word selected from the set of code words as input to the hashing algorithm;
generating, by the at least one noise-resistant feature transformation and hashing module, a first public key and a first private key, using the first hash; and
electronically signing, with the first private key, a data item associated with the user.

2. The method of claim 1 further comprising:
receiving, by the processor, user input identifying a condition satisfying a threshold requirement for use of the first biometric measurement to verify authenticity of a second data item associated with the user;
generating, by the biometrics reader device, a second biometric measurement using the physical characteristic of the user;
generating, by the at least one noise-resistant feature transformation and hashing module, a second hash, wherein generating the second hash further comprises executing the hashing algorithm and using the selected code word as input to the hashing algorithm;
generating, by the at least one noise-resistant feature transformation and hashing module, a second private key, using the second hash;
electronically signing, with the second private key, the second data item; and
verifying the authenticity of the signed second data item using the first public key.

3. A method for multi-factor, biometrics-based, secure data encryption by a user, the method including:
generating, by a biometrics reader device, a first biometric measurement using a physical characteristic of a user;
selecting, by at least one noise-resistant feature transformation and hashing module executing on a processor of a computing device, a code word in a set of code words, wherein selecting further comprises applying an error correcting code to the first biometric measurement;
generating, by the at least one noise-resistant feature transformation and hashing module, a first hash, wherein generating further comprises executing a hashing algorithm and using the selected code word as input to the hashing algorithm;
generating, by the at least one noise-resistant feature transformation and hashing module, a public key and a private key, using the first hash; and
encrypting data associated with the user with the public key.

4. The method of claim 3 further comprising:
receiving, by the processor, user input identifying a condition satisfying a threshold requirement for use of the first biometric measurement to retrieve the encrypted data;
generating, by the biometrics reader device, a second biometric measurement using the physical characteristic of the user;
generating, by the at least one noise-resistant feature transformation and hashing module, a second hash, wherein generating the second hash further comprises executing the hashing algorithm and using the selected code word as input to the hashing algorithm;
generating, by the at least one noise-resistant feature transformation and hashing module, a second public key and a second private key, using the second hash;
decrypting, by the processor, the encrypted data with the second private key; and
providing, by an encryption module of the at least one noise-resistant feature transformation and hashing module, the user with access to the decrypted data.

5. A method for biometrics-based secure data recovery, the method comprising:
generating, by a biometrics reader device, a first biometric measurement using a physical characteristic of a user;
selecting, by at least one noise-resistant feature transformation and hashing module executing on a processor of a computing device, a code word in a set of code words, wherein selecting further comprises applying an error correcting code to the first biometric measurement;
generating, by the at least one noise-resistant feature transformation and hashing module, a first hash of the code word;
encrypting, by an encryption module of the computing device, a data item, using the first hash as input to an encryption algorithm;
receiving, by the processor, user input identifying a condition satisfying a threshold requirement for use of the first biometric measurement to retrieve the data item;
generating, by the biometrics reader device, a second biometric measurement using the physical characteristic of the user;
applying, by the at least one noise-resistant feature transformation and hashing module, the error correcting code to the second biometric measurement;
generating a second hash using an output of applying the error correcting code to the second biometric measurement;
decrypting, by the processor, the data item using the second generated hash as input to the decryption algorithm; and
providing, by the encryption module, the user with access to the data item.
